(19) United States
(12) Patent Application Publication
(10) Pub. No.: US 2010/0178400 A1
(43) Pub. Date: Jul. 15, 2010

(54) Method of Preparing a Whole Grain Beverage

(75) Inventors: Ricardo Pereyra, White Plains, NY (US); William Mutilangi, Peekshill, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NY (US)

(21) Appl. No.: 12/353,023

(22) Filed: Jan. 13, 2009

(51) Int. Cl. A23L 2/44; A23L 2/38

(52) U.S. Cl. 426/330.3; 426/590

(57) ABSTRACT

A method for preparing a whole grain beverage via steam injection is described. More particularly, the method includes the steps of dispersing whole grain flour in a product batch to form a product mixture and subjecting the product mixture to steam injection to obtain a whole grain beverage. The whole grain beverage produced by this method has overall enhanced stability.

### FIELD OF THE INVENTION

The present invention relates generally to the preparation of a whole grain beverage. More particularly, this invention relates to a method for preparing a whole grain beverage via steam injection.

### BACKGROUND

In today's fast-paced society, convenience foods and beverages are frequently consumed by individuals with busy lifestyles. However, many convenience foods and beverages are not healthy and contain so-called “empty calories,” thereby providing the consumer with energy, but little or no micronutrients such as vitamins, minerals, or fiber. Therefore, a need exists for a nutritious and healthy food or beverage, such as a whole grain beverage. Whole grains have many beneficial attributes, including lowering cholesterol, and reducing the risk of obesity and heart disease.

Moreover, a need exists for a whole grain beverage with enhanced overall stability and drinkability. Methods traditionally used to reduce the viscosity of whole grain flour and water dispersions for use in beverages include subjecting the flour to a colloid mill or enzymatically treating the mixture to reduce the viscosity. However, such methods have significant drawbacks. For example, using a colloid mill to lower the viscosity of a whole grain flour and water dispersion is extremely time consuming, as the dispersion must be treated with the colloid mill for at least 45 minutes. Adding an enzyme to the flour-water dispersion to reduce the viscosity is also extremely disadvantageous, as these enzymes must be purchased or manufactured at a significant cost. Moreover, the enzyme hydrolyzes the starch in the flour thereby modifying the structure of the flour, causing the flour to lose its standard of identity as “whole grain.” If the flour loses its standard of identity as “whole grain” one cannot make particular FDA-approved health claims relating to the flour.

### BRIEF SUMMARY

The present invention relates to a whole grain beverage and the method of preparing the whole grain beverage. In particular, the present invention relates to a method of preparing the whole grain beverage including fully dispersing whole grain flour in a product batch and processing the batch using steam injection to produce a whole grain beverage.

In one aspect of the present invention, the product mixture may include at least one food-grade ingredient selected from the group consisting of condensed milk, flavors, salt, sugar, juice, and other food-grade ingredients.

### DETAILED DESCRIPTION OF THE INVENTION

The present invention relates to whole grain beverages. In particular, the present invention relates to a method of preparing a whole grain beverage by dispersing whole grain flour in a product batch and processing using steam injection.

The present invention uses steam injection to reduce the viscosity of the mixture and produce a beverage with enhanced overall stability while maintaining the grain's standard of identity as “whole grain.” “Enhanced overall stability” as used herein shall refer to a product appearing homogeneous (i.e., not separated into two or more phases). Additionally, the present invention provides a beverage with enhanced mouthfeel and appearance. The method for preparing a whole grain beverage as set forth herein greatly diminishes grain sedimentation and the course/sandy/gritty texture associated with many whole grain beverages.

The method for preparing a whole grain beverage as further described herein, includes fully dispersing whole grain flour in a product batch and subjecting the product batch to steam injection to produce a whole grain beverage.

In accordance with the present invention, whole grain flour is fully dispersed in a product batch. In one aspect of the present invention, the product batch includes at least water and at least one stabilizer. The at least one stabilizer is dispersed in water heated to about 60-150° F. Any suitable stabilizer can be used with the present invention including gellan gum, carrageenan, cellulose gel, cellulose gum, pectin, modified food starch, agar, guar gum, xanthan gum, propylene glycol alginate, locust bean gum, gum arabic, or mixtures thereof. The whole grain flour may be fully dispersed in the product batch by heating the product batch and whole grain at a temperature of about 60-150° F. for about 2-180 minutes and mixing at a speed of about 100 RPM to 2000 RPM to form a product mixture. Equipment such as a steam jacketed kettle or Scott Turbon Mixer can be used to fully disperse the stabilizer in the water and/or fully disperse the flour in the product batch.

After fully dispersing the whole grain flour in the product batch to form a product mixture, the product mixture is subjected to steam injection. More particularly, the steam injection used in accordance with one aspect of the present invention is direct steam injection, an ultra high temperature pasteurization method readily available in the beverage industry. For example, a temperature of about 275-305° F. may be used to process the product mixture for about 2-3 seconds. In accordance with one aspect of the present invention, the steam is heated to about 290° F. Superheated steam is injected directly into the pipe where the product is flowing. The pressure of the steam injector is about 30 psi or greater. In accordance with another aspect of the present invention, following formation of the product mixture, the product mixture may be transferred to a kettle, wherein substantially all of this mixture in the kettle is sent through a pipe, to the steam injector, and then to a filler where the whole grain beverage is packaged.

By using steam injection to process the product mixture, the starch contained in the grains implodes, thereby breaking down the starch and resulting in a product with reduced viscosity. “Low viscosity” or “reduced viscosity” as used herein means about 50 cPs when measured at a temperature of about 40° F.

The flour used in accordance with the present invention may be derived from cereal whole grains. Examples of such cereal whole grains include, but are not limited to oats, barley, wheat, corn, rice, quinoa and mixtures of these grains. One of ordinary skill in the art would appreciate that other cereal whole grains could be used in accordance with the present invention.

In one aspect of the present invention, about 0.01-14% by weight whole grain flour may be present in the whole grain beverage. More specifically, about 0.1% to about 7% by weight whole grain flour may be present in the beverage. For instance, 4% by weight of oat flour can be used in the method.

The particle size of the grain flour used in accordance with the present invention may vary based on the type of beverage and consistency desired. The average particle size of the flour used in accordance with the present invention may range from about 50 microns to about 150 microns. For example, in one aspect of the present invention, the average particle size of the oat flour is about 90 microns.

Numerous ingredients may be included in the product mixture of the present invention. Such ingredients may be selected from the group consisting of dairy-based ingredients, juices, sugars, salts, flavors and mixtures thereof. The sugars that can be used in the invention may include, but are not limited to sucrose, fructose, high fructose corn syrup (HFCS), Lo Han Guo, artificial sweeteners such as acesulfame potassium, sucralose, and others. In accordance with one aspect of the present invention, condensed milk, sucrose, salt, and flavors are included in the product batch. Any suitable flavor may be used with the present invention including, but not limited to fruit flavors, vanilla, maple brown sugar, caramel, and chocolate.

An example of one embodiment of the present invention includes weighing the gum (if more than one gum, weigh gums separately), such as carrageenan. The carrageenan is then dry blended and dispersed in about 40 gallons of approximately 150° F. treated or purified water at high shear using a Scott Turbon Mixer at speed of about 4 for about 10 minutes. The water may be treated or filtrated by using methods conventionally used in the beverage industry, such as ultrafiltration or reverse osmosis. The shear speed is slowly reduced to a speed of about 2, and subsequently, approximately 30 gallons of treated water at room temperature is added to the hydrated gum to form the product batch. Oat flour is then added to the product batch and the speed is increased to 3 (high shear) for 15 minutes. Milk is then added, along with additional ingredients, such as natural or artificial flavors including grain flavor, cereal flavor, and mixed berry flavor. The milk used in accordance with the present invention may be whole, reduced fat and/or skim milk. Following incorporation of the additional ingredients to the product mixture, the total solids content is measured. Approximately 10 gallons of water is then added to the product mixture. The total solids content is measured. Lastly, the pH of the product mixture is adjusted using potassium carbonate (20% solution). The product mixture is then subjected to steam injection for about 2 seconds at a temperature of about 290° F. to produce a whole grain oat beverage. The whole grain oat beverage may then be packaged.

The invention may be embodied in other specific forms without departing from the spirit or essential characteristics thereof. The foregoing embodiments, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

What is claimed is:

1. A method of preparing a whole grain beverage comprising the steps of:
a) introducing a whole grain flour into a product batch containing at least water and at least one stabilizer, and dispersing the whole grain flour in the product batch to form a product mixture; and
b) subjecting the product mixture to steam injection at a temperature of about 275-305° F. for a time sufficient to form a whole grain beverage.

2. The method of claim 1 wherein the whole grain flour is selected from the group consisting of oats, wheat, rice, corn, rice, quinoa, barley and mixtures thereof.

3. The method of claim 1 wherein the product mixture also contains at least one food-grade ingredient.

4. The method of claim 3 wherein the at least one food-grade ingredient is selected from the group consisting of dairy-based ingredients, juices, sugar, salts, flavors, and mixtures thereof.

5. The method of claim 3 wherein the at least one food-grade ingredient is condensed milk, sugar, salt, and flavor.

6. The method of claim 3 wherein the at least one food-grade ingredient is juice, sucrose, salt, and flavors.

7. The method of claim 5 wherein the flavor is selected from the group consisting of fruit flavors, vanilla, maple brown sugar, caramel, chocolate and combinations thereof.

8. The method of claim 1 wherein about 0.1-7% whole grain flour is present in the whole grain beverage.

9. The method of claim 1 wherein the whole grain flour has an average particle size of about 50 microns to about 150 microns.

10. The method of claim 1, wherein the at least one stabilizer is selected from the group consisting of gellan gum, carrageenan, cellulose gel, cellulose gum, pectin, modified food starch, agar, guar gum, xanthan gum, propylene glycol alginate, locust bean gum, gum arabic, and combinations thereof.

11. The method of claim 1 wherein the product mixture is subjected to steam injection for about 2-3 seconds.

12. The whole grain beverage prepared using the method of claim 1.

13. A method of preparing a whole grain beverage comprising the steps of:
a) introducing a whole grain flour into a product batch to form a product mixture, the product batch including water, at least one stabilizer, and the product mixture containing at least one food-grade ingredient selected from the group consisting of a dairy-based ingredient, juice, sucrose, salt, flavor and mixtures thereof, and
b) subjecting the product mixture to steam injection at a temperature of about 275-305° F. for a time sufficient to form a whole grain beverage.

14. The method of claim 13 wherein the whole grain flour is selected from the group consisting of oats, wheat, rice, corn, quinoa, barley and mixtures thereof.

15. The method of claim 13 wherein the whole grain maintains its standard of identity as whole grain.

16. The method of claim 13 wherein the beverage stability is obtained.

17. The whole grain beverage prepared using the method of claim 13.

18. The method of claim 13 wherein the whole grain flour is oat flour, the at least one stabilizer is gellan gum, and the at least one food-grade ingredient is condensed milk, sucrose, salt, and flavor.

19. The method of claim 13 wherein the whole grain flour is oat flour, the at least one stabilizer is gellan gum and the at least one food-grade ingredient is juice, sucrose, salt and flavor.

20. The method of claim 18 wherein the flavor is selected from the group consisting of maple brown sugar, caramel, chocolate and combinations thereof.

21. The method of claim 19 wherein the flavor is selected from the group consisting of maple brown sugar, caramel, chocolate and combinations thereof.

22. The method of claim 13 wherein the at least one stabilizer is selected from the group consisting of gellan gum, carrageenan, cellulose gel, cellulose gum, pectin, modified food starch, agar, guar gum, xanthan gum, propylene glycol alginate, locust bean gum, gum arabic, and combinations thereof.

23. The method of claim 13 wherein the product mixture is subjected to steam injection for about 2-3 seconds.
